(19) United States
(12) Patent Application Publication
(10) Pub. No.: US 2020/0380543 A1
(43) Pub. Date: Dec. 3, 2020

(54) DETERMINING PARTICULARS OF AN ITEM IN AN ONLINE MARKETPLACE

(71) Applicant: GETWORTH (PTY) LTD, Cape Town (ZA)

(72) Inventors: Jamie Kazimierz SURKONT, Cape Town (ZA); Mark Eden RIDGWAY, Cape Town (ZA); Colin Bruce MORGAN, Cape Town (ZA)

(21) Appl. No.: 16/471,535

(22) PCT Filed: Dec. 15, 2017
(86) PCT No.: PCT/IB2017/057995

§ 371 Date: Jun. 19, 2019

(30) Foreign Application Priority Data
Dec. 19, 2016 (ZA) 2016/08711

(51) Int. Cl. G06Q 30/02; G06Q 30/06

(52) U.S. Cl. CPC G06Q 30/0206; G06Q 30/0641; G06Q 30/0201

(57) ABSTRACT

A system and method for determining item particulars associated with an item in a marketplace are provided. In a method conducted at a server, an item record including information relating to an item is received from a communication device. Reference records obtained from a plurality of information sources and being analogous to the item record are identified. Item particulars are dynamically determined from the identified reference records using a computational component. The item particulars include a transfer value associated with the item and a time limit linked to the transfer value. The server outputs the transfer value and the time limit to a device. The transfer value represents an initial amount payable by an intermediary in favour of a seller of the item. The time limit represents a period of time in which the seller can control a target value for which the item will be sold to a buyer.

### CROSS-REFERENCE TO RELATED APPLICATION

This application claims priority from South African provisional patent application number 2016/08711 filed on 19 Dec. 2016, which is incorporated by reference herein.

### FIELD OF THE INVENTION

This invention relates to online marketplaces and in particular to an intermediated online marketplace in which an intermediary facilitates the sale of an item from a seller to a buyer. In particular, the invention relates to the determination of item particulars of an item for sale in an intermediated online marketplace.

### BACKGROUND TO THE INVENTION

There are various online marketplaces which allow a buyer to purchase an item directly from a seller. There are for example websites on which sellers can advertise the item and provide contact information by way of which interested buyers can contact the seller to arrange a viewing and conclude the sale. In such a case, negotiation of the terms of the sale is left to the seller and the buyer. It can for example be difficult to determine a realistic price for the item, meaning that either the seller or the buyer may end up being prejudiced. While sellers and buyers alike can turn to similar items for sale for an indication of what the price should be, there is no guarantee that this price is an accurate reflection of the value of the item or that it is the price that actually ends up being paid. There are other drawbacks associated with such online marketplaces, for example the threat of scammers, the safety of the sellers and buyers, transaction costs, and the like. Furthermore, the activity of sellers on online marketplaces may be affected by their liquidity requirements, often leading to sellers selling items for less than their value so as to receive much needed cash.

There are no adequate technological solutions to problems such as these and there is accordingly room for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method for determining item particulars associated with an item in a marketplace, the method being conducted at a remotely accessible server and comprising: receiving, from a communication device, an item record including information relating to an item; identifying reference records which are analogous to the item record, the reference records having been obtained from a plurality of information sources accessible via a communication network;

dynamically determining, from the identified reference records, item particulars using a computational component, wherein the item particulars include a transfer value associated with the item and a time limit linked to the transfer value; and, outputting the transfer value and the time limit to a communication device, wherein the transfer value represents an initial amount payable by an intermediary in favour of a seller of the item and wherein the time limit represents a period of time in which the seller is able to control, via a communication device, a target value representing an amount payable by a buyer in favour of the intermediary in order to buy the item.

Further features provide for the method to include outputting at least a subset of the information included in the item record and the target value to a publicly accessible item profile; for the communication device to access a portal which includes a graphical user interface via which sale parameters are adjustable; and for the portal to include one of a seller portal and an administrator portal, the method including providing seller access to the seller portal. The seller may be able to adjust parameters of the sale and view the probability of making a sale based on the adjusted sale parameters as well as the financial outcome after fees, costs, etc.

A still further feature provides for the item particulars further to include one or more of: a computer-recommended price, a time prediction relating to an expected sale time associated with the computer-recommended price, a volatility indication associated with the computer-recommended price, and a variability indication associated with the computer-recommended price or time prediction, wherein the item particulars are determined to account for expected future fluctuations, and wherein the transfer value and/or time limit is based on one or more of the further item particulars. Multiple computer-recommended prices may be determined for selection by the seller.

A yet further feature provides for the target value to be based on the computer-recommended price. The target value may be a list price at which the item is listed for sale.

The target value may be based on a computer-recommended price and a seller adjustable factor, wherein the seller adjustable factor is adjustable via the seller portal within predetermined limits.

Further features provide for the method to include dynamically updating the target value and an associated time limit in response to adjustment of the seller adjustable factor and outputting the updated target value to the publicly accessible item profile. The seller adjustable factor may be a positive or negative value added to the target value or may be a scaling factor such that the target value is larger or smaller than the selected computer-recommended price.

Yet further features provide for the method to include obtaining a base price being equal to or lower than the target value and representing a threshold above which offers to purchase received by the intermediary are not required to be approved by the seller, wherein the base price is adjustable by the seller via the seller portal within predetermined limits; and, outputting the base price to one or both of the seller portal or the administrator portal.

Further features provide for the method to include determining, based on the item particulars, one or more exit prices and associated deadlines, the exit prices and associated deadlines representing amounts payable and deadlines by which seller election is required to be received should a seller wish to exit the online marketplace; and, outputting the one or more exit prices and associated deadlines to one or both of the seller portal or the administrator portal.

Still further features provide for the method to include obtaining a transfer value range and outputting the transfer value range to the seller via the seller portal for selection of a transfer value within the transfer value range.

Yet further features provide for the method to include receiving a message indicating a seller exiting the marketplace; and, restricting seller access to the seller adjustable factor, wherein the message is received from one of the seller portal or the administrator portal.

Even further features provide for the method to include monitoring the time limit to detect expiry and, upon expiry of the time limit, transmitting a notification to the communication device and/or restricting seller access to the seller adjustable factor.

A further feature provides for the method to include dynamically determining the time limit associated with the target value using one or more of the item particulars, a transfer value and the computational component.

Still further features provide for the method to include, in response to detecting expiry of the time limit, transmitting a notification to the communication device.

Yet further features provide for the reference records to be stored in a database, the method including maintaining the database by continuously or periodically accessing the plurality of information sources to update the reference records in the database.

Further features provide for the method to include receiving a sale confirmation indication from the communication device, the indication including a sale price at which the item is to be sold; and determining an additional amount based at least on the difference between the sale price and the transfer value; and, outputting the additional amount to the communication device.

In accordance with a further aspect of the invention there is provided a system for determining item particulars associated with an item in a marketplace, the system including a remotely accessible server having a memory for storing computer-readable program code and a processor for executing the computer-readable program code, the remotely accessible server comprising: an item record receiving component for receiving, from a communication device, an item record including information relating to an item; a reference record identifying component for identifying reference records which are analogous to the item record, the reference records having been obtained from a plurality of information sources accessible via a communication network; an item particulars determining component for dynamically determining, from the identified reference records, item particulars using a computational component, wherein the item particulars include a transfer value associated with the item and a time limit linked to the transfer value; and, an output component for outputting the transfer value and the time limit to a communication device, wherein the transfer value represents an initial amount payable by an intermediary in favour of a seller of the item and wherein the time limit represents a period of time in which the seller is able to control, via a communication device, a target value representing an amount payable by a buyer in favour of the intermediary in order to buy the item

The remotely accessible server may include a profile outputting component for outputting at least a subset of the information included in the item record and a target value being based upon the item particulars to a publicly accessible item profile.

A still further feature provides for the item particulars to include one or more of: a computer-recommended price, a time prediction relating to an expected sale time associated with the computer-recommended price, a volatility indication associated with the computer-recommended price, and a variability indication associated with the computer-recommended price or time prediction. Multiple computer-recommended prices may be determined for selection by the seller, wherein the item particulars are determined to account for expected future fluctuations, and wherein the transfer value and/or time limit is based on one or more of the further item particulars.

A yet further feature provides for the target value to be based on the computer-recommended price. The target value may be a list price at which the item is listed for sale.

Further features provide for the communication device to provide a seller portal; for the remotely accessible server to include a seller portal providing component for providing seller access to the seller portal, the seller portal including a graphical user interface via which the seller is able to adjust parameters of the sale and view the probability of making a sale based on the adjusted sale parameters.

Still further features provide for the remotely accessible server to include a target value obtaining component for obtaining the target value based on a computer-recommended price and a seller adjustable factor, wherein the seller adjustable factor is adjustable by the seller via the seller portal within predetermined limits; and, for the profile outputting component to output the updated target value to the publicly accessible item profile. The seller adjustable factor may be a negative value or may be a scaling factor such that the target value is larger or smaller than the selected computer-recommended price.

Yet further features provide for the remotely accessible server to include a base price obtaining component for obtaining a base price being lower than the target value and representing a threshold above which offers to purchase received by the intermediary are not required to be approved by the seller, wherein the base price is adjustable by the seller via the seller portal within predetermined limits; and, a portal output component for outputting the base price to one or both of the seller portal or the administrator portal.

Further features provide for the remotely accessible server to include an exit price determining component for determining, based on the item particulars , one or more exit prices and associated deadlines, the exit prices and associated deadlines representing amounts payable and deadlines by which seller election is required to be received should a seller wish to exit the online marketplace; and, a portal output component for outputting the one or more exit prices and associated deadlines to one or both of the seller portal or the administrator portal.

Still further features provide for the remotely accessible server to include a transfer value obtaining component for determining a transfer value range and outputting the transfer value range to the seller via the seller portal for selection of a transfer value within the transfer value range.

Yet further features provide for the remotely accessible server to include a message receiving component for receiving a message indicating a seller exiting the marketplace; and, an access restricting component for restricting seller access to the seller adjustable factor, wherein the message is received from one of the seller portal or the administrator portal.

Still further features provide for the remotely accessible server to include a transmitting component for, in response to determining that the time limit has expired, transmitting a notification to one or both of the seller portal or the administrator portal and for the access restricting component to restrict seller access to the seller adjustable factor.

Yet further features provide for the reference records to be stored in a database and for the remotely accessible server to include a database maintaining component for maintaining the database including continuously or periodically accessing the plurality of information sources to update the reference records in the database.

Further features provide for the remotely accessible server to include an indication receiving component for receiving a sale confirmation indication from the administrator portal indicating that the item is to be sold, the indication including a sale price at which the item is to be sold; an additional amount determining component for determining an additional amount based at least on the difference between the sale price and the transfer value; and, for a portal output component for outputting the additional amount to one or both of a seller portal or an administrator portal.

In accordance with a further aspect of the invention there is provided a computer program product for determining item particulars associated with an item in a marketplace, the computer program product comprising a computer-readable medium having stored computer-readable program code for performing the steps of: receiving, from a communication device, an item record including information relating to an item; identifying reference records which are analogous to the item record, the reference records having been obtained from a plurality of information sources accessible via a communication network; dynamically determining, from the identified reference records, item particulars using a computational component, wherein the item particulars include a transfer value associated with the item and a time limit linked to the transfer value; and, outputting the transfer value and the time limit to a communication device, wherein the transfer value represents an initial amount payable by an intermediary in favour of a seller of the item and wherein the time limit represents a period of time in which the seller is able to control, via a communication device, a target value representing an amount payable by a buyer in favour of the intermediary in order to buy the item.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system for determining item particulars in an online marketplace;

FIG. 2 is a flow diagram which illustrates an exemplary method for determining item particulars in an online marketplace;

FIG. 3 is a block diagram which illustrates an exemplary system for determining item particulars in an online marketplace;

FIG. 4 is a schematic diagram which illustrates an exemplary graphical user interface (GUI) that may be provided by a seller portal described herein;

FIG. 5 illustrates a screen-shot of an exemplary graphical user interface (GUI) that may be provided by seller portal according to aspects of the present disclosure; and

FIG. 6 illustrates an example of a computing device in which various aspects of the disclosure may be implemented.

### DETAILED DESCRIPTION WITH REFERENCE TO THE DRAWINGS

The system and method described herein provide an intermediated online marketplace in which items may be transferred from sellers to buyers via an intermediary. The term “item” as used herein should be broadly construed to include any tangible or intangible property which may be transferred from a seller to a buyer. For simplicity, the remainder of the description is described with reference to a scenario in which the intermediated online marketplace is used for the transfer of items being motor cars. However, it should be appreciated that the description which follows may be implemented mutatis mutandis in item-agnostic scenarios or in scenarios relating to any other type or group of items. In a practical implementation of the described system and method, the intermediary may take ownership of the item (e.g. by completing a contract of sale and purchase with the seller) for on-selling the item to third party buyers.

In the intermediated online marketplace, a seller may transfer possession of the item to the intermediary in return for payment of a ‘transfer value’ by the intermediary to the seller. The seller thus enters the marketplace and thereafter, the intermediary may advertise the item for sale to third party buyers. While the item is advertised for sale, the seller (the original seller) may continue to adjust the price for which the item is advertised for sale, the ‘target value’ (or ‘list price’), for a specified time limit. Once a buyer choses to buy the item, an additional amount may be determined by subtracting the transfer value and the intermediary's fees (which may include repair costs, etc.) from the sale price (the price at which the buyer buys the item). This additional amount is then paid over to the original seller. The seller may have the option to exit the marketplace at various scheduled points in time, in response to which the seller will receive payment of an ‘exit price’ and will thereafter no longer be involved in the sale of the item by the intermediary to third party buyers.

Aspects of the disclosure make use of a computational component, which may be a machine learning component, which is configured to dynamically determine various values and parameters described herein. The computational component may have access to expansive data sets to enable real-time optimal price and expected time line prediction. Some of the values, prices and parameters described herein may be interrelated and the computational component may continually update values in response to changes to dependent values. Use of the computational component and data sets may enable forecasting via a seller portal to allow a seller to observe how different target values will affect expected sales times thus enabling real-time selection of target values that best suit the seller's individual needs.

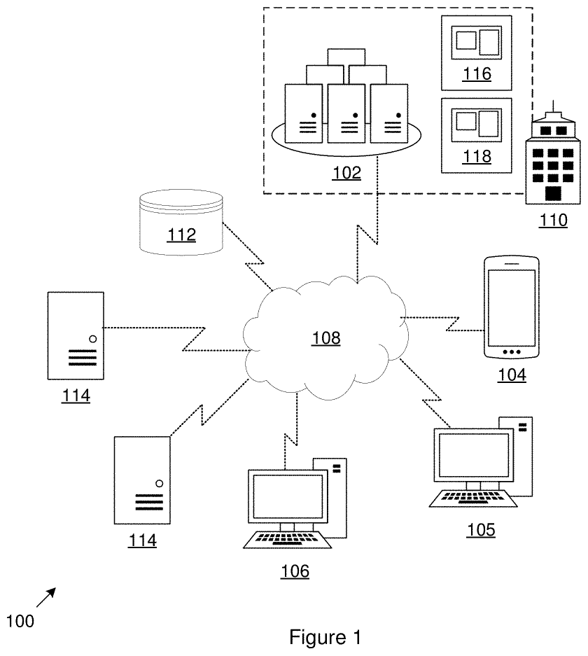

FIG. 1 is a schematic diagram which illustrates an exemplary system (100) for determining item particulars of an item for sale on an online marketplace. The system (100) may include a remotely accessible server (102), a seller communication device (104), a buyer communication device (105) and an intermediary communication device (106).

The remotely accessible server (102) and communication devices (104, 105, 106) may communicate via an appropriate communication network (108), such as the Internet.

The remotely accessible server (102) may be maintained, operated or rented by an intermediary (110). The remotely accessible server (102) may be any appropriate server computer, cloud-based server computer, distributed server computer or the like. In some implementations, the physical location of the remotely accessible server (102) may be unknown and may be irrelevant to the operation of the system and method described herein.

The remotely accessible server (102) may have access to a database (112) and to one or more information sources (114). The information sources (114) may include one or more of the group of: sales portals; online marketplaces (e.g. classified websites); wholesale trade websites (e.g. online auction websites); item seller records; expert pricing assessments (e.g. internally generated or third party pricing assessments); market indicators (e.g. general item price indices, inflation rate, interest rates, etc.) and the like.

The remotely accessible server (102) may store a number of reference records in the database (112). Each reference record may relate to a class of item (e.g. to a make and model of a motor car) or to a specific item (e.g. a particular make and model motor car from a specific year and having a particular mileage, specified optional extras, etc.). The reference records may have been obtained and built up from information available from the information sources (114) to which the remotely accessible server (102) has access. The reference records may include item particulars of the items to which they relate. In some implementations the remotely accessible server (102) may maintain the reference records in the database by continuously or periodically accessing the information sources (114) to update the reference records stored in the database.

The remotely accessible server (102) may host an intermediated online marketplace via which sellers may sell items to buyers. The intermediated online marketplace may provide a mechanism by way of which a seller of an item may receive compensation in two stages: initially a defined amount at the time of sale to the intermediary (the transfer value) and a second portion at the time of sale of the item by the intermediary to a third party buyer. The amount for which the item is sold by the intermediary to the third party buyer may be determined by the initial seller (i.e. the seller having sold the item to the intermediary). The intermediated online marketplace described herein may transfer further risk and costs in the item transfer (or sale) to the intermediary. A fee structure may be implemented that is deducted from the ultimate amount for which the item was sold by the intermediary to the third party buyer (“the sale price”). The fee structure may not apply if the selling price does not cover the fees and costs.

The remotely accessible server (102) may provide remote portals including a seller portal (116) via which the seller may access the intermediated online marketplace and an administrator portal (118) via which the intermediary may access the intermediated online marketplace. The portals (116, 118) may be remotely accessible using the seller communication (104) device or an intermediary communication device (106) respectively. The portals may be in the form of password protected websites which are only accessible to entities having the correct username/password combinations, an appropriate software application (e.g. a mobile software application downloadable onto the communication device) or the like. The portals (116, 118) may enable the seller and administrator to interact with the intermediated online marketplace, receive notifications, input data and instructions, analyse data and the like.

The seller may have an online account with the remotely accessible server (102) via which the seller may access the seller portal. The seller may record and manage the item record and various particulars relating to the sale of the item via the seller portal (116) and/or the seller online account. The online account may also include other deals (e.g. the result of his consignment or straight sales deals). The seller portal may also display market data (e.g. an indication of sales, probability of sale at the target value, expected time to sell at the target value, etc.) in order to encourage the seller to select a realistic target value. The seller portal may also display the probability of making a sale based on adjusted sale parameters as well as the financial outcome after fees, costs, etc.

As will be described in greater detail below, the seller may use the seller portal (116) to control various aspects of the sale of the item via the intermediated online marketplace. The seller may use the seller portal to select a transfer value from a transfer value range. Different transfer values within the transfer value range may be linked to different time limits. The seller may use the seller portal (116) to control the target value for an initial period (e.g. up until expiry of the time limit). In some implementations, a lower transfer value and/or target value will result in lower fees, and vice versa. Further, selecting a lower transfer value from the transfer value range may increase the time limit in which the seller will be able to control the target value, and vice versa. The seller may also be able to control a base price via the seller portal (116).

The seller portal (116) may provide a dynamic graphical user interface via which the seller can adjust these various parameters. The graphical user interface may provide a number of sliders, dials or other graphical components (e.g. for ‘transfer price’, ‘time limit’, ‘fees’) and adjusting any one of the components may cause the other components to adjust appropriately (e.g. increasing the ‘transfer price’ slider may cause the ‘fees’ slider to increase and the ‘time limit’ slider to decrease). The graphical user interface may also display various parameters relating to the sale of the item, such as time limits, prices, the probability of making a sale based on the adjusted sale parameters, etc. Sliders or other graphical components may also be provided for adjusting and previewing net amounts received by the seller versus various listing prices and time periods. The seller portal may also permit the seller to view exit price outcomes and deadlines by which the seller needs to elect to exit, and provide a means of communicating that election to the intermediary.

Once the item is listed on the intermediated online marketplace (once the seller has entered the online marketplace), the seller may use the seller portal (116) to view the status of the sale. The seller portal (116) may provide an analytics engine which may show one or more of: statistics on the item type in the market (which may be accompanied by a probability of sale at the current target value); enquiries received and/or interest expressed in the item; amount of time remaining before the time limit is reached; accumulated cash, costs and fees at that particular point in time, and the like.

The seller portal (116) may influence the seller's price expectations to be realistic; educate the seller on the trade-off between time and money; maximise the probability of the item being sold before the time limit is reached; automate the seller interactions as far as possible; lead to a degree of gamification (the seller is, to some extent, in control).

The seller portal may accordingly communicate various benefits to the seller by means of the graphical user interface and may allow the seller to manage a portfolio of items via a series of trading screens, each showing respective metrics. Exemplary metrics may include run-time and equity, compared to original and current market price assessments.

The portals may enable any suitable communication between the remote server and seller or administrator. In some implementations, the portal may enable communication via email, chat (e.g. a chat bot), interactive voice response and the like.

The communication devices (104, 105, 106) may be any appropriate electronic devices capable of communicating via the communication network (108). Exemplary communication devices include computing devices (e.g. desktop or laptop computers, smart appliances, gaming consoles, etc.), mobile communication devices (e.g. mobile phones, smart phones, wearable computing devices, tablet computers, personal digital assistants, etc.) or the like. The communication devices (104, 105, 106) may be configured to access the remotely accessible server (102) and/or the intermediated online marketplace via the communication network (108). The communication devices (104, 105, 106) may be configured to receive notifications from the intermediated online marketplace, input data and instructions to the intermediated online marketplace, analyse data and the like.

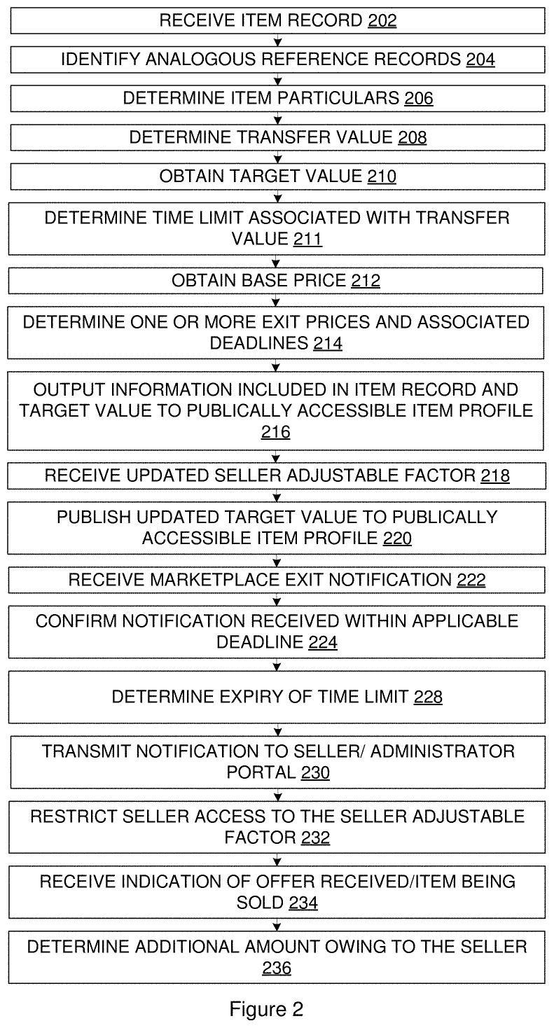

The system (100) described above may implement a method for determining item particulars of an item for sale in an online marketplace. An exemplary method for determining item particulars of an item for sale in an online marketplace is illustrated in FIG. 2.

The remotely accessible server (102) may provide a seller portal (116) and an administrator portal (118). The remotely accessible server (102) may maintain the database (112) including continuously or periodically accessing the plurality of information sources (114) to update the reference records in the database (112). Maintaining the database may include using the computational component of the remotely accessible server. For example, suitable pattern recognition, artificial neural network learning, support vector machine learning algorithms and the like may be used to label reference records which are gathered from the information sources. This may enable automated gathering and classification of data relating to items which are sold via the online marketplace.

A seller wishing to sell an item, such as a motor car, may approach the intermediary (110). The seller may approach the intermediary via the seller portal (116), physically (e.g. by travelling to the intermediary's premises) by telephone, email, chat app, etc. The seller may provide information relating to the item to the intermediary. The information provided may include any appropriate information which may be used in establishing the value of the item. In the case of a motor car, for example, the information may include the make, model, year, service history, mileage, body condition (presence of scratches, dents, etc. on the bodywork), accident history, running condition, details of optional extras, details of aftermarket accessories, photographs of the item, and the like. The information relating to the item may be filled in on a form (written or digitally via the seller portal (116)).

The remotely accessible server (102) may receive (202) an item record including the information relating to the item to be sold. The remotely accessible server (102) may receive the information from a data capturing process (e.g. via a manual or automated process capturing the information from a form filled in by the seller) or via the seller portal (116).

The remotely accessible server (102) may identify (204) reference records which are analogous to the item record. The reference records may be stored in the database (112) and may have been obtained from the plurality of information sources (114). In other implementations, the reference records may be obtained dynamically upon receipt of the item record. Obtaining the reference records may include cleaning and/or filtering data which is mined from the plurality of information sources (114). Obtaining the reference records may include grouping or classifying like items with each other. For example, motor cars of the same make and model may be grouped or classified together. Identifying (204) reference records may include using the information relating to the item to be sold to structure an appropriate query to locate reference records which are analogous (or otherwise similar or equivalent in certain respects) to the item record. Identifying the reference records may use the computational component of the remotely accessible server. For example, suitable pattern recognition, artificial neural network learning, support vector machine algorithms and the like may be used to identify reference records which are similar to the item record.

The remotely accessible server (102) may determine (206) item particulars of the item using the identified reference records. The item particulars which are determined may be item pricing particulars. The item particulars may include one or more of the group of: one or more computer-recommended prices; time predictions relating to an expected sale time associated with each computer-recommended price; a measure of the expected volatility of each of the one or more computer-recommended prices (e.g. an indication of the propensity for prices to change with time); an indication of the liquidity of the item (e.g. an indication of how frequently analogous items are traded); regional variances (e.g. an indication of how pricing may change depending on the geographical region); supply/demand statistics; inferences which are based on similar or related data; estimates in relation to items for which there are no similar data records; pattern recognition outputs; a variability indication associated with each price and/or time prediction; a confidence indicator indicating the confidence in the accuracy of the item particulars, and the like. The item particulars may be determined to account for expected future price fluctuations. The item particulars may for example take into account the risk of not conducting a sale and the period for which the price will be valid. The item particulars may be forward looking.

The liquidity indication may indicate an expected period of time it would take to sell the item at a realistic price. The indication of the liquidity of the item may be important to know as the intermediary's fees and costs may accumulate over time, thereby reducing the margin between the eventual sale price and the intermediary's costs to the date of sale. As the market and circumstances may change over time, the price and risk assessment needs to be done for each deal.

Knowledge of the confidence may be useful in evaluating risk associated with the sale of the item. The confidence indicator may be based on the amount of data available and whether it is sufficient for an accurate prediction, the presence of other factors that may make it difficult to predict the computer-recommended price, whether or not the prices fluctuate widely, and the like.

The one or more computer-recommended prices may include a computer-recommended retail price and a computer-recommended wholesale price. An expected sale time associated with each price may indicate a time (e.g. number of days, weeks or months) in which the item is likely to be sold at the price with which the expected sale time is associated. In some implementations, multiple computer-recommended retail prices and/or multiple computer-recommended wholesale prices may be determined, each of which may be associated with an expected sale time. “Retail price” as used herein refers to a price at which a retailer would sell the item to prospective consumers (end users) while “wholesale price” refers a price at which the item may be purchased by dealers (e.g. at an auction, from a seller or from other dealers).

Knowledge of wholesale price may be useful as it may represent the price at which the item could be sold in a ‘fire-sale’ (e.g. an auction) and/or may be used as a relative measure in determining one or more of the transfer value, exit prices and applicable time limits.

The item particulars may for example indicate, for a particular make and model of a motor vehicle, inventory in the market, recent price history, what the expected trend for the next few months is, inventory levels and speed of sales, and the like.

Determining (206) item particulars may use the computational component. The computational component may implement any appropriate algorithms, including, for example, machine learning algorithms (e.g. artificial neural networks, pattern recognition, support vector machines, deep learning, clustering etc.), statistical regression models and the like. The algorithms may be dynamic and may adjust as information and conditions change with time, as more data is added, etc. In some implementations, the algorithms may be created by a machine learning training model while other implementations may adjust the algorithm based on the !earnings from a statistical data analytics model. The training model/data analytics model may evolve and become more sophisticated with time.

Determining item particulars using the computational component may enable more precise pricing to be estimated. Further, additional, inter-related parameters can also be catered for, e.g., the trade-off between cash, time, wholesale and retail pricing, volatility, etc.

Using a computational component may also enable scalability. Determining item particulars using a computational component and its associated algorithms may enable rapid determination of item particulars (e.g. in “real-time” or within a few fractions of a second). In some implementations, determining item particulars for a particular item may continue to provide updated item particulars for the duration that the item is for sale on the intermediated online marketplace. Doing so may enable proactive action in response to the detection of adverse changes. In some implementations, determining item particulars may use a periodically updated statistical model, which may result in item particulars being determined more rapidly and with less computational burden, while in other implementations the statistical model may be updated dynamically in real-time.

The item particulars may be used to control the risk to which the intermediary is exposed. A higher risk may result in a lower transfer value or a shorter time limit associated with a transfer value. Risk may also affect the exit price levels that may be offered and/or the fee levels.

In some implementations, the item particulars may include a transfer value associated with the item and a time limit which is linked to the transfer value. The time limit may be linked to the transfer value in that it is dependent upon the transfer value. A change in the transfer value may result in a corresponding change to the time limit. The remotely accessible server (102) may accordingly obtain (208) a transfer value. The transfer value may be based on or include one or more of a computer-recommended price, a selected computer-recommended price and remaining item particulars. The remotely accessible server (102) may output the transfer value to one or both of a seller portal or an administrator portal.

In some implementations, obtaining the transfer value may include determining a transfer value range and outputting the transfer value range to the seller via the seller portal for selection of a transfer value within the transfer value range. The selected computer-recommended price may be selected by the intermediary or by the seller based on the expected sale time associated with the particular computer-recommended price that is selected. This may adjust the transfer value. The transfer value may be less than the selected computer-recommended price, e.g. between 50 and 90 percent of the selected computer-recommended price. The transfer value may be obtained from the seller or the intermediary (e.g. via their respective portals) and may be stored in association with the item record. The transfer value may reflect the amount of cash that is paid upfront (i.e. on completion of the agreement and when the item is transferred from the seller to the intermediary) to the seller by the intermediary. The transfer value may be selectable by the seller within predetermined limits (e.g. between maximum and minimum values). In the intermediated online marketplace described herein, once the transfer value has been paid by the intermediary to the seller and the item has been transferred from the seller to the intermediary, the intermediary offers the item for sale to third party buyers via a publicly accessible item profile, which may include a website hosted by the intermediary and/or third party online classified websites. However, the seller may still be able to control the price for which the item is sold (the target value) and may be entitled to share in the difference between the sale price (i.e. the eventual price for which the item is sold) and the transfer value, subject to certain fees which may be levied by the intermediary.

The remotely accessible server (102) may obtain (210) a target value, in this implementation being a list price, for which the item is to be sold. The target value may be based on the selected computer-recommended price (or the target value) as well as a seller adjustable factor. Obtaining (210) the target value may include providing seller access to the seller adjustable factor to allow a seller to interactively adjust the seller adjustable factor (e.g. using sliders, dial or other inputs provided by the seller portal) and receiving the adjusted seller adjustable factor. In some implementations, the seller adjustable factor may be adjustable within predetermined parameters (e.g. between 90% and 110% of the selected computer-recommended price, etc.). The seller adjustable factor may be a positive or negative value (e.g. a portion to be added to or subtracted from the selected computer-recommended price) or may be a scaling factor such that the target value may be adjusted to being larger or smaller than the selected computer-recommended price. The seller may be able to adjust the seller adjustable factor for the duration that the item is available for sale on the online marketplace, subject to certain restrictions which are discussed below. The target value may be stored in association with the item record.

The remotely accessible server (102) may determine (211) a time limit associated with the target value and/or the transfer value. The time limit may represent the length of time during which the seller has the right to set and/or update the target value. Upon expiry of the time limit, seller access to the seller adjustable factor may be restricted so as to prevent further updates by the seller to the target value. The time limit may be determined by the remotely accessible server (102) using one or more of the item particulars, the target value, transfer value and the computational component. The time limit may be determined based on the interaction between predictions of future market price (including volatility, confidence and time to sell (velocity)) and the transfer value. In other implementations, the time limit may be determined based on the predictions of future market price and time required or some combination thereof. Determining (211) the time limit may include dynamically adjusting the time limit in response to adjustment of the target value and/or transfer value using the computational component and associated insights.

The remotely accessible server (102) may also obtain (212) a base price. The base price may be constricted to be lower than the target value and may represent a threshold above which offers to purchase received by the intermediary are not required to be approved by the seller. Offers below the base price may need to be presented to the seller for his or her approval. The base price is adjustable by the seller via the seller portal (e.g. using sliders, dial or other inputs provided by the seller portal), subject to the restriction that it cannot be greater than the target value. The base price may be stored in association with the item record.

The remotely accessible server (102) may determine (214), based on the item particulars, one or more exit prices and associated deadlines. The exit prices and associated deadlines may represent amounts payable and deadlines by which seller election is required to be received should a seller wish to exit the online marketplace. The exit prices and associated deadlines may be stored in association with the item record. The exit prices may represent amounts which the seller can, during the associated deadline, opt to receive, thereby exiting the marketplace.

Should the seller elect to redeem the exit price within the associated deadline, the seller may be paid the difference between the exit price and the transfer value. Election to redeem the exit price may waive any of the seller's rights to share in any surplus which may be realised upon sale of the item by the intermediary to a third party buyer. The exit price may be a function of the various prices described herein (e.g. one or more of retail, wholesale, transfer, computer-recommended prices, etc.). For example, the exit price may be 90% of the wholesale price within 30 days of deal inception, 88% of the wholesale price within days 31-60 days, etc.

The remotely accessible server (102) may output (216) at least a subset of the information included in the item record and the target value to a publicly accessible item profile. The publicly accessible item profile may be accessible to the public via a website hosted by the remotely accessible server (102) and may be accessible by prospective buyers using a buyer communication device (105).

While the item is available for sale, and before expiry of the time limit, the seller may continue to adjust the target value via the seller portal (116). The remotely accessible server (102) may receive (218) an updated seller adjustable factor, store the updated target value (reflecting the updated seller adjustable factor) in association with the item record and publish (220) the updated target value to the publicly accessible item profile. The seller may accordingly control the target value for a defined period (i.e. for the duration of the time limit) and the remotely accessible server may dynamically adjust time limits and other values dependent on the target value.

At some stage, the seller may decide to exit the marketplace. The seller may for example use the seller portal (116) to transmit a marketplace exit notification to the remotely accessible server (102). In other scenarios, the marketplace exit notification may be received from the administrator portal (118) in response to the seller communicating to the administrator the seller's desire to exit the marketplace. The remotely accessible server (102) may receive (222) the marketplace exit notification and may confirm (224) that the notification is received within an applicable deadline. If the notification is received within the applicable deadline (i.e. a deadline associated with an exit price that is still valid), the remotely accessible server (102) may determine the exit price associated with the applicable deadline and communicate the exit price to one or both of the seller portal and the administrator portal. In response to receiving the message indicating the seller exiting the marketplace, the remotely accessible server (102) may restrict seller access to the seller adjustable factor. A mechanism is therefore provided by way of which the seller can “cash out” of the deal by accepting a pre-defined price at certain points in time.

The remotely accessible server (102) may continually monitor the time limit. In some cases the remotely accessible server (102) may determine (228) that the time limit has expired. In response, the remotely accessible server (102) may transmit (230) a notification to one or both of the seller portal (116) or the administrator portal (118) and may restrict (232) seller access to the seller adjustable factor. After this point the seller may no longer adjust pricing (that becomes the intermediary's prerogative), but the seller might earn an additional payment if the intermediary manages to sell the item for an amount that more than covers the transfer value, fees and costs.

The remotely accessible server (102) may at some stage receive (234) a sale confirmation indication from the administrator portal (118) indicating that an offer in respect of the item has been received or that the item has been sold. The indication may include a sale price at which the item was or is to be sold and the remotely accessible server (102) may determine (236) an additional amount, based on the difference between the sale price and the transfer value, which is owing to the seller. This may be preceded by determining whether the seller has exited the marketplace, in which case an additional amount is not determined. Determining (236) the additional amount may also include determining fees that are payable by the seller and which may be subtracted from the additional amount. The additional amount and/or the fees may be stored in association with the item record and may be included in a sale notification transmitted to one or both of the seller and administrator portals (116, 118).

Determining the fees payable may consider the item and transfer value. The fees may not be levied until the item has been sold by the intermediary to a third party buyer and should the item sell at a sale price which is lower than the fees and the transfer value already paid, the loss may be absorbed by the intermediary. In other iterations, the seller may be responsible for portion of the shortfall, subject to pre-determined limits.

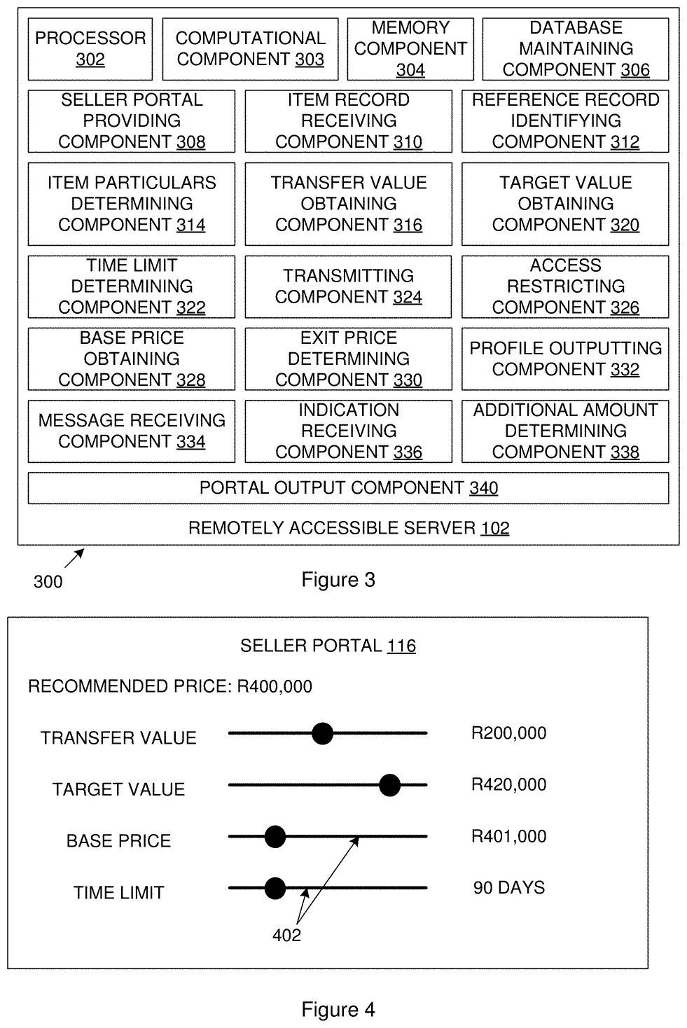

FIG. 3 is a block diagram which illustrates an exemplary system (300) for determining item particulars of an item for sale in an online marketplace. The system (300) may be arranged to implement a method for determining item particulars of an item for sale in an online marketplace, such as the method described above with reference to FIG. 2. The system includes a remotely accessible server (102).

The remotely accessible server (102) may include a processor (302) for executing the functions of components described below, which may be provided by hardware or by software units executing on the remotely accessible server (102). The software units may be stored in a memory component (304) and instructions may be provided to the processor (302) to carry out the functionality of the described components.

The remotely accessible server (102) may include a computational component (303). The computational component may be arranged to provide dynamic and real-time (e.g. within a few seconds or milliseconds) determination of item particulars, values, prices and time limits and the like. The computational component may implement suitable algorithms (such as those described in the foregoing) and may access and/or update the database in order to determine optimal values which are specific to a particular item under consideration.

The remotely accessible server (102) may include a database maintaining component (306) arranged to maintain the database (112) in which reference records may be stored. The database maintaining component (306) may be arranged to continuously or periodically access the plurality of information sources (114) to update the reference records in the database (112). In other implementations, the reference records are obtained from the plurality of information sources (114) in real-time, as and when required. The database maintaining component (306) may use the computational component (303) to identify and/or classify information available from the information sources.

The remotely accessible server (102) may include a seller portal providing component (308) arranged to provide seller access to the seller portal (116). The seller portal (116) may be accessible by the seller using the seller communication device (104) and may include a graphical user interface via which the seller is able to adjust various parameters of the sale.

The remotely accessible server (102) may include an item record receiving component (310) arranged to receive an item record including information relating to an item to be sold on the marketplace. The item record may be received from either the administrator portal or the seller portal.

The remotely accessible server (102) may include a reference record identifying component (312) which may be arranged to identify reference records which are analogous to the item record. The reference records may be obtained from the plurality of information sources in real-time or from the database (112). In some implementations the reference record identifying component (312) may use a computer-implemented statistical algorithm to identify the reference records which are analogous to the item record. The reference record identifying component (312) may use the computational component (303) to identify reference records which are analogous to the item record.

The remotely accessible server (102) may include an item particulars determining component (314) for determining, from the identified reference records, item particulars. The item particulars may include one or more of the group of: one or more computer-recommended prices; an expected sale time associated with each price; a measure of the expected volatility of each of the one or more computer-recommended prices (e.g. an indication of the propensity for prices to change with time); an indication of the liquidity of the item (e.g. an indication of how frequently analogous items are traded); regional variances (e.g. an indication of how pricing may change depending on the geographical region); and, a confidence indicator indicating the confidence in the accuracy of the item particulars. The item particulars determining component (314) may use the computational component (303), as described above.

The remotely accessible server (102) may include a transfer value obtaining component (316) arranged to obtain a transfer value based on a selected computer-recommended price. The transfer value may be adjustable by the seller via the seller portal within predetermined limits.

The remotely accessible server (102) may include a target value obtaining component (320) arranged to obtain the target value for which the item is to be sold based on a selected computer-recommended price (or transfer value) plus an additional seller adjustable factor. The seller adjustable factor is adjustable by the seller via the seller portal (116) within predetermined limits.

The remotely accessible server (102) may also include a time limit determining component (322) arranged to determine a time limit associated with the target value and/or transfer value. The time limit determining component (322) may use the item particulars and the target value and/or transfer value in order to determine an appropriate time limit. The seller may be able to adjust the target value via the seller portal up until expiry of the time limit (which may for example be as long as 90 days). Upon expiry of the time limit, seller access to the seller adjustable factor is restricted to thereby restrict the seller from updating the target value. The remotely accessible server (102) may further include a transmitting component (324) arranged to transmit a notification to one or both of the seller portal or the administrator portal in response to determining that the time limit has expired. The remotely accessible server (102) may further include an access restricting component (326) arranged to restrict seller access to the seller adjustable factor upon expiry of the time limit.

The remotely accessible server (102) may include a base price obtaining component (328) arranged to obtain a base price. The base price may be lower than the target value and may represent a threshold above which offers for the purchase of the item will be considered by the intermediary. The base price may be adjustable by the seller via the seller portal (116) within predetermined limits.

The remotely accessible server (102) may include an exit price determining component (330) arranged to determine, based on the item particulars, one or more exit prices and associated deadlines. The exit prices and associated deadlines may represent amounts payable and deadlines by which seller election is required to be received should a seller wish to exit the online marketplace. The exit price determining component (330) may provide the exit prices and associated deadlines to the seller portal for election to exit thereat

The remotely accessible server (102) may include a profile outputting component (332) arranged to output at least a subset of the information included in the item record and the target value to a publicly accessible item profile (e.g. to a website which is accessible to buyers).

The remotely accessible server (102) may include a message receiving component (334) arranged to receive a message indicating a seller exiting the marketplace. The message may be received from one of the seller portal or the administrator portal and the remotely accessible server (102) may be configured to confirm that the message is received within an appropriate deadline. In response to receiving the message and confirming that the message is received within the appropriate deadline, the access restricting component (326) may restrict seller access to the seller adjustable factor.

The remotely accessible server (102) may include an indication receiving component (336) arranged to receive a sale confirmation indication from the administrator portal indicating that the item is to be sold (or that an offer for purchase in respect of the item has been received). The indication may include a sale price at which the item is to be sold. The remotely accessible server (102) may include an additional amount determining component (338) arranged to determine an additional amount based on the difference between the sale price and the transfer value and taking into account fees and costs levied by the intermediary.

The remotely accessible server (102) may further include an output component, which may be in the form of a portal output component (340), and may be arranged to output information and/or data to the communication devices described herein (in some cases via the portal). The portal output component (340) may be arranged to output the transfer value and the time limit to a remote portal (e.g. the seller portal and/or administrator portal). The portal output component (340) may further be arranged to output one or more of: the base price; the one or more exit prices and associated deadlines; and, the additional amount to one or both of the seller portal or the administrator portal.

In some implementations, remotely accessible server (102) may include a dynamic fee adjustment component which is configured to dynamically adjust fees based on risk, item particulars and/or the business or portfolio needs of the intermediary. The remotely accessible server (102) may further include a pricing and risk assessment engine for evaluating the pricing and risk assessment.

FIG. 4 is a schematic diagram which illustrates one example of a graphical user interface (GUI) that may be provided by the seller portal (116). The GUI includes a number of sliders (402) via which the seller can adjust one or more of: the transfer value, the target value, the base price and the time limit. As mentioned in the foregoing, adjusting one of the values using the sliders may cause one or more other values to be adjusted appropriately. For example increasing the transfer value may reduce the time limit or vice versa. The GUI provided by the seller portal (116) enables a user to dynamically adjust various sales parameters. Some of the parameters, in particular the target value, may be adjusted after the seller has entered the marketplace (i.e. after the seller has received a payment corresponding to the transfer value and has transferred the item into the possession of the intermediary).

The system and method described herein may enable one or more of selling items, gaming, bridge funding, boosting cash availability, debt mitigation, and best value outcome. The system and method may provide flexibility in the effect of balancing a seller's immediate cash requirements against the time to realise the best overall commercial outcome. The system and method may be advantageous in scenarios in which: the market is not very liquid; there is a large price spread between the buying and selling price for a quick sale (i.e. the price difference between a trade and retail offer is substantial); there is a significant information asymmetry between trade buyers and retail sellers; an item seller needs to trade in one item (of a reasonably substantial value) in order to buy another (e.g. vehicles/residential properties); and the like. The system and method described herein may provide a professional product which may enable a seller to buy back the underlying item as well as buy out of the product (i.e. exit the marketplace). In some cases, sellers may be able to retain possession of the item even after receipt of the transfer value (e.g. in cases where the seller needs to sell an item as they are emigrating but needs use of the item until the day of departure).

The system and method described herein may allow a seller to realise immediate cash (i.e. the transfer value) and terminate further item holding costs/risks without needing to settle for a lower price (as is often the case in existing online marketplaces). The system and method may alleviate (by way of the transfer value) financial constraints which often force sellers to trade in the existing items prior to or at the same time as buying new items. Further risks of fraud or safety may be alleviated by the sale of the item via a trusted intermediary. The described systems and methods may also alleviate the information asymmetry which may make the sale of items difficult and/or stressful for individual sellers. The described system and method may enable the traditional and uncertain item holding costs or risks to be replaced with a fixed fee structure which is offset against the item sale price to a third party buyer. The described system and method may also provide the seller with the opportunity of receiving a higher sale price by way of sale of the item at a retail price level (by the intermediary). The seller may also enjoy interaction with the sale, despite having reduced his or her risk.

In the system and method described herein, item pricing may be determined by means of data and algorithms based on retail and wholesale price points and variances, time to sell for similar items in market, quantum and quality of data available, expert predictions and the like. The algorithms may include neural networks or other suitable statistical means. The item pricing may change progressively over time (i.e. the surplus realised by the seller may be reduced by fees which increase as time passes). This may obviate the need to conduct an upfront assessment of the velocity of sale, which may be technically difficult to achieve (e.g. where a price control period is offered to the customer). The system and method may further provide a seller with the choice between an outright sale and a two-part sale. In a practical implementation, a mechanism may be provided by way of which the seller can “buy out” of the deal by paying the original transfer value plus fees and costs accrued to date to thereby reclaim the item.

The system and method described herein may provide a product where a seller can dispose of an item, receive an initial payment (based on a determined transfer value) and then drive the selling price of the disposed item themselves, for their own financial gain. The described system and method may accordingly provide an end-to-end product which may bridge multiple market applications (e.g. buy, sell, pawn, speculate) as well as allowing buy out or buy back alternatives. The described system and method may also facilitate trading by sellers who are short of cash, as a transfer value may be paid immediately without losing out on the opportunity of realising the full value of the item.

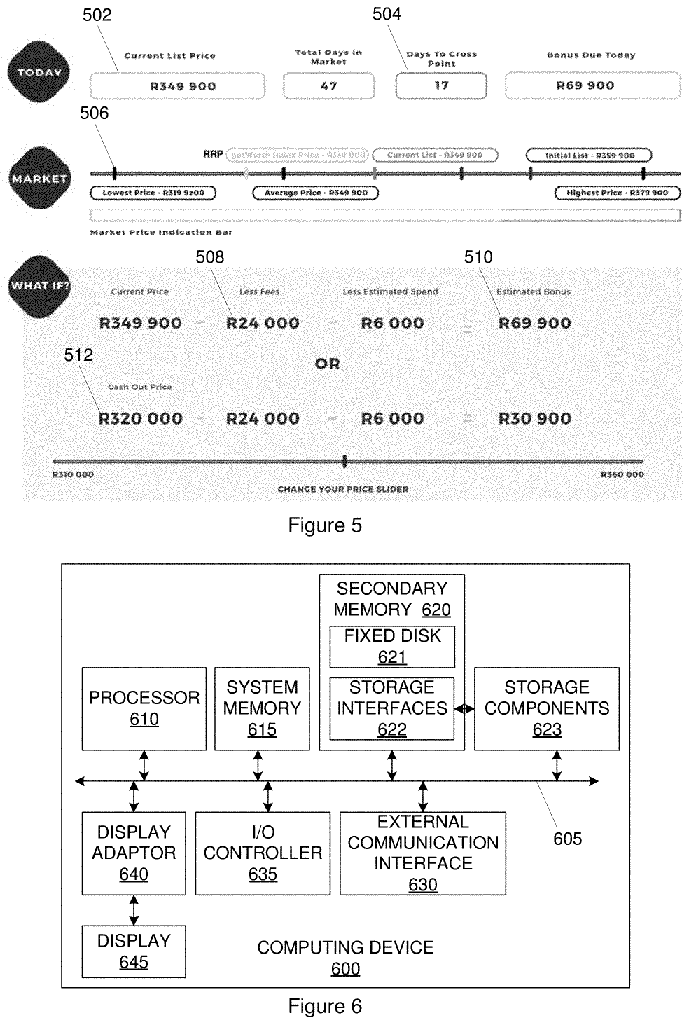

FIG. 5 illustrates a screen-shot of an exemplary seller portal according to aspects of the present disclosure. The seller portal displays a target value (502) and an associated time limit (504) representing an amount of time in which the seller has to sell the item at the target value.

The seller portal displays a market price indication bar (506) illustrating various prices associated with the item. The seller portal displays fees (508) and spend which would be deducted from the target value (502) if it were realised to arrive at an additional amount (510) which would be payable to the seller if the target value were to be realised. The seller portal displays an exit price (512) representing a price that the seller can elect to realise (minus the associated fees), in turn relinquishing the ability to control the target value further.

FIG. 6 illustrates an example of a computing device (600) in which various aspects of the disclosure may be implemented. The computing device (600) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (600) may be suitable for storing and executing computer program code.

The various participants and elements in the previously described system diagrams may use any suitable number of subsystems or components of the computing device (600) to facilitate the functions described herein. The computing device (600) may include subsystems or components interconnected via a communication infrastructure (605) (for example, a communications bus, a network, etc.). The computing device (600) may include one or more processors (610) and at least one memory component in the form of computer-readable media. The one or more processors (610) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (600) may be distributed over a number of physical locations (e.g. in a distributed, cluster or cloud-based computing configuration) and appropriate software units may be arranged to manage and/or process data on behalf of remote devices.

The memory components may include system memory (615), which may include read only memory (ROM) and random access memory (RAM). A basic input/output system (BIOS) may be stored in ROM. System software may be stored in the system memory (615) including operating system software. The memory components may also include secondary memory (620). The secondary memory (620) may include a fixed disk (621), such as a hard disk drive, and, optionally, one or more storage interfaces (622) for interfacing with storage components (623), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (600) may include an external communications interface (630) for operation of the computing device (600) in a networked environment enabling transfer of data between multiple computing devices (600) and/or the Internet. Data transferred via the external communications interface (630) may be in the form of signals, which may be electronic, electromagnetic, optical, radio, or other types of signal. The external communications interface (630) may enable communication of data between the computing device (600) and other computing devices including servers and external storage facilities. Web services may be accessible by and/or from the computing device (600) via the communications interface (630).

The external communications interface (630) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (610). A computer program product may be provided by a non-transient computer-readable medium, or may be provided via a signal or other transient means via the communications interface (630).

Interconnection via the communication infrastructure (605) allows the one or more processors (610) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (600) either directly or via an I/O controller (635). One or more displays (645) (which may be touch-sensitive displays) may be coupled to or integrally formed with the computing device (600) via a display (645) or video adapter (640).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims. Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method for determining item particulars associated with an item in a marketplace, the method being conducted at a remotely accessible server and comprising:
receiving, from a communication device, an item record including information relating to an item;
identifying reference records which are analogous to the item record, the reference records having been obtained from a plurality of information sources accessible via a communication network;
dynamically determining, from the identified reference records, item particulars using a computational component, wherein the item particulars include a transfer value associated with the item and a time limit linked to the transfer value; and,
outputting the transfer value and the time limit to a communication device,
wherein the transfer value represents an initial amount payable by an intermediary in favour of a seller of the item and wherein the time limit represents a period of time in which the seller is able to control, via a communication device, a target value representing an amount payable by a buyer in favour of the intermediary in order to buy the item.

2. The method as claimed in claim 1, including outputting at least a subset of the information included in the item record and the target value to a publicly accessible item profile.

3. The method as claimed in claim 1, wherein the item particulars further include one or more of: a computer-recommended price, a time prediction relating to an expected sale time associated with the computer-recommended price, a volatility indication associated with the computer-recommended price, and a variability indication associated with the computer-recommended price or time prediction, wherein the item particulars are determined to account for expected future fluctuations, and wherein the transfer value and/or time limit is based on one or more of the further item particulars.

4. The method as claimed in claim 3, wherein the target value is based on the computer-recommended price.

5. The method as claimed in claim 1, wherein the communication device accesses a portal which includes a graphical user interface via which sale parameters are adjustable.

6. The method as claimed in claim 3, wherein the target value is based on the computer-recommended price and a seller adjustable factor, wherein the seller adjustable factor is adjustable via the communication device within predetermined limits.

7. The method as claimed in claim 6, including dynamically updating the target value in response to adjustment of the seller adjustable factor and outputting the updated target value to a publicly accessible item profile.

8. The method as claimed in claim 6, including monitoring the time limit to detect expiry and, upon expiry of the time limit, restricting seller access to the seller adjustable factor.

9. The method as claimed in claim 8, including, in response to detecting expiry of the time limit, transmitting a notification to the communication device.

10. The method as claimed in claim 1, wherein the reference records are stored in a database, the method including maintaining the database by continuously or periodically accessing the plurality of information sources to update the reference records in the database.

11. The method as claimed in claim 1 including:
receiving a sale confirmation indication from the communication device, the indication including a sale price at which the item is to be sold; and
determining an additional amount based at least on the difference between the sale price and the transfer value; and, outputting the additional amount to the communication device.

12. The method as claimed in claim 5, wherein the portal includes a seller portal, the method including providing seller access to the seller portal.

13. A system for determining item particulars associated with an item in a marketplace, the system including a remotely accessible server having a memory for storing computer-readable program code and a processor for executing the computer-readable program code, the remotely accessible server comprising:
an item record receiving component for receiving, from a communication device, an item record including information relating to an item;
a reference record identifying component for identifying reference records which are analogous to the item record, the reference records having been obtained from a plurality of information sources accessible via a communication network;
an item particulars determining component for dynamically determining, from the identified reference records, item particulars using a computational component, wherein the item particulars include a transfer value associated with the item and a time limit linked to the transfer value; and,
an output component for outputting the transfer value and the time limit to a communication device,
wherein the transfer value represents an initial amount payable by an intermediary in favour of a seller of the item and wherein the time limit represents a period of time in which the seller is able to control, via a communication device, a target value representing an amount payable by a buyer in favour of the intermediary in order to buy the item.

14. A computer program product for determining item particulars associated with an item in a marketplace, the computer program product comprising a computer-readable medium having stored computer-readable program code for performing the steps of:
receiving, from a communication device, an item record including information relating to an item;
identifying reference records which are analogous to the item record, the reference records having been obtained from a plurality of information sources accessible via a communication network;
dynamically determining, from the identified reference records, item particulars using a computational component, wherein the item particulars include a transfer value associated with the item and a time limit linked to the transfer value; and,
outputting the transfer value and the time limit to a communication device,
wherein the transfer value represents an initial amount payable by an intermediary in favour of a seller of the item and wherein the time limit represents a period of time in which the seller is able to control, via a communication device, a target value representing an amount payable by a buyer in favour of the intermediary in order to buy the item.
